(19) United States
(12) Patent Application Publication
(10) Pub. No.: US 2026/0264956 A1
(43) Pub. Date: Sep. 10, 2026

(54) STRUCTURE OF PACKAGING BAG

(71) Applicant: 1teck Automation Technology Co., Ltd., Tongxiang (CN)

(72) Inventor: TUNG-LUNG CHIANG, Tongxiang (CN)

(21) Appl. No.: 19/071,734

(22) Filed: Mar. 5, 2025

(51) Int. Cl. B65D 81/03; B65D 33/10; B65D 65/46; B65D 81/38

(52) U.S. Cl. CPC B65D 81/03; B65D 33/105; B65D 65/466; B65D 81/3897

(57) ABSTRACT

A packaging bag includes an outside wall surface, an inside wall surface, a containing space, a buffer body, an unfixed outer side surface, honeycomb cells, a peripheral edge, a high edge, cell edges, and an included angle. The buffer body is made in a prefabricated shaped form in advance to be subsequently disposed in the containing space. The unfixed outer side surface is arranged on one side of the buffer body facing the inside wall surface and is completely not fixed to the inside wall surface. The buffer body is made to present honeycomb cells in multiple three-dimensional (3D) configurations by means the cell edges of the peripheral edge, the included angle, and the high edge, so as to be directly placeable into the packaging bag in an already-expanded form without the necessity of adhesively bonding and fixing to the inside wall surface of the packaging bag.

### BACKGROUND OF THE INVENTION

### (a) Technical Field of the Invention

The present invention relates to a structure of packaging bag having honeycomb paper that can be directly placed in the packaging bag in an expanded form without adhesively bonded to and fixed to an inside wall surface of the packaging bag for easy setup to thereby achieve advantages of convenience and environmental friendliness and also exhibits advantages of shock resistance, buffering, cold keeping, heat preservation, and thermal insulation.

### (b) Description of the Prior Art

In the process of transporting or storing goods, in order to prevent the goods from being damaged by various factors, such as shaking, collision, and displacement, generally at least one protective packaging material is added to the packaging structure of the goods, such as foam, bubble bags, cushions, or styrofoam, to prevent or reduce the damage of the goods.

However, in the known art, the goods are generally placed in a packaging box or packaging bag first, and then protective packaging materials such as foam, bubble bags, cushions, or styrofoam are used to cover the goods to achieve the effect of anti-collision and fixation. Although this method can reduce the damage of the goods, overall, the packaging process is too cumbersome and tedious, and the protective packaging materials required will also take up a lot of space. After the packaging is completed, the shape is relatively irregular and difficult to store. In particular, the material used is very environmentally unfriendly and cannot be recycled, and the function is relatively simple, serving only as a buffering function without other additional functions.

### SUMMARY OF THE INVENTION

The primary objective of the present invention is to provide an arrangement featuring a buffer body in a prefabricated shaped form and an unfixed outer side surface to allow the buffer body to present, after placed in a packaging bag, a plurality of honeycomb cells in an expanded three-dimensional (3D) configuration without being fixed to an inside wall surface of the packaging bag after being, so that, in addition to the advantage of being quickly set up, the packaging bag also exhibits the advantages of shock resistance, buffering, cold keeping, heat preservation, and thermal insulation, and that due to the buffer body being made of paper, the present invention also shows the advantage of environmental friendliness.

The structure that the present invention adopts to achieve the above objective comprises an outside wall surface, an inside wall surface, a containing space, at least one buffer body, an unfixed outer side surface, a plurality of honeycomb cells, a peripheral edge, a high edge, a plurality of cell edges, and an included angle, wherein the inside wall surface is located opposite to the outside wall surface, and the inside wall surface surrounds and defines the containing space, and the buffer body is made in a prefabricated shaped form and disposed in the containing space, and the unfixed outer side surface is located at the side of the buffer body that facing the inside wall surface, and the unfixed outer side surface is not fixed on the inside wall surface, and further, the honeycomb cells are formed on the buffer body, and each of the honeycomb cells comprises a peripheral edge in a polygonal form and a high edge extending from the peripheral edge in a vertical direction so as to make the honeycomb cell forming a three-dimensional configuration, and finally, the peripheral edge includes the aforesaid cell edges, and the aforesaid included angle is formed between each of the cell edges.

When the buffer body is to be placed in the containing space, since the buffer body itself is prefabricated in a pre-shaped form that is in an expanded three-dimensional (3D) form in advance, a user can directly place the buffer body in the containing space, and while being so placed, the buffer body is kept not fixed to the inside wall surface due to the unfixed outer side surface, that is, after the buffer body is placed in the containing space, the honeycomb cells can be presented in a three-dimensional (3D) configuration in the containing space by means of the peripheral edges and the high edge without using any fixing technology (such as glue).

By using the above technology, the problems of the conventional packaging bags that the packaging process is too complicated, and the protective packaging materials required also take up a lot of space, and the outside shape of the packaging is relatively irregular and difficult to store, and particularly, the material used is very environmentally unfriendly and cannot be recycled, and the function is relatively simple, only serving as a buffer without other additional functions can be overcome to thereby achieve practical improvement for the above advantages of the present invention.

### BRIEF DESCRIPTION OF THE DRAWINGS

FIG. 1 is an exploded view of a first embodiment.

FIG. 2 is a perspective view showing a buffer body according to the first embodiment.

FIG. 3 is a perspective sectional view illustrating placing according to the first embodiment.

FIG. 4 is a schematic sectional view illustrating merchandise object protecting according to the first embodiment.

FIG. 5 is a schematic sectional view illustrating impact buffering according to the first embodiment.

FIG. 6 is a schematic sectional view illustrating isolating according to a second embodiment.

FIG. 7 is a perspective view showing a buffer body according to a third embodiment.

FIG. 8 is a cross-sectional view of a fourth embodiment.

FIG. 9 is a cross-sectional view of a fifth embodiment.

FIG. 10 is a schematic view showing a packaging bag according to a sixth embodiment.

### DETAILED DESCRIPTION OF THE PREFERRED EMBODIMENTS

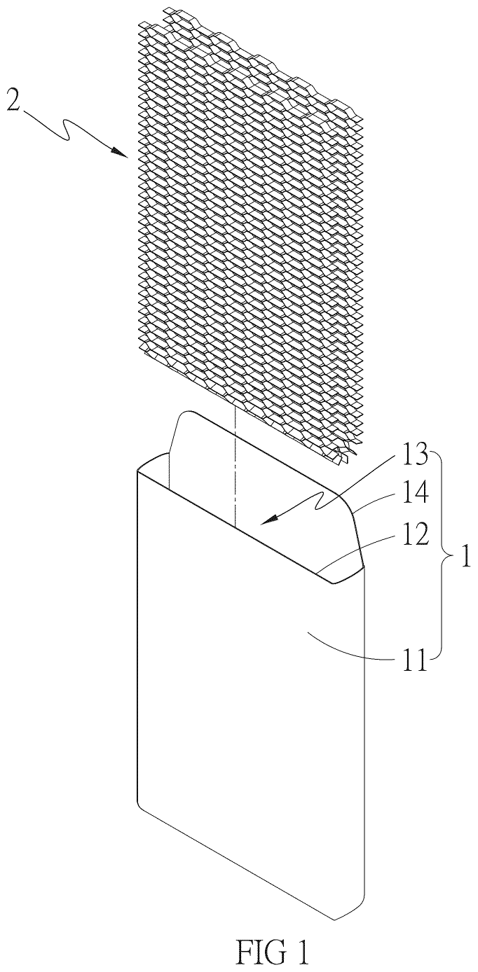

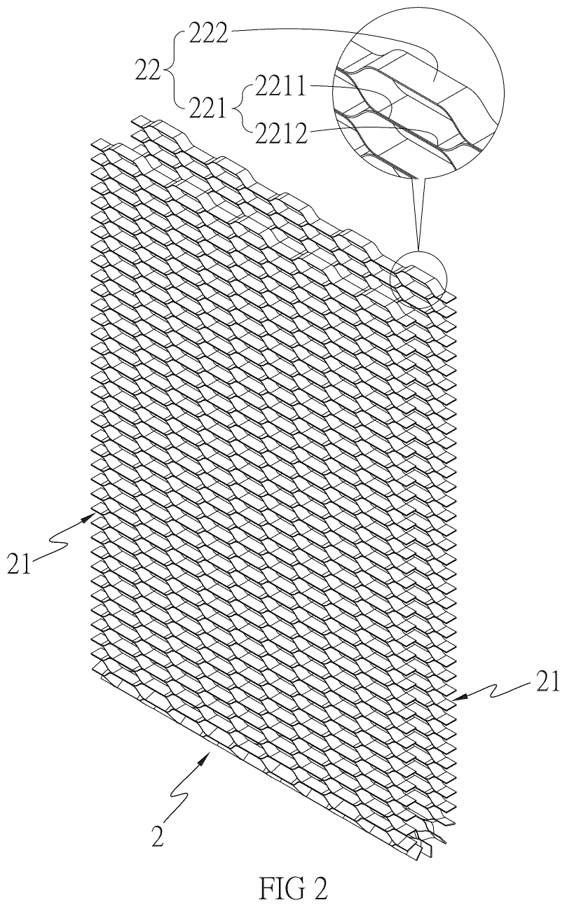

Referring to FIGS. 1 and 2, a packaging bag 1 comprises:
an outside wall surface 11;
an inside wall surface 12, which is located on a side opposite to the outside wall surface 11, the inside wall surface 12 surrounding and forming a containing space 13;
at least one buffer body 2, which is disposed in the containing space 13 in a prefabricated shaped form and is made of a biodegradable paper material, the buffer body 2 having an unfixed outer side surface 21 facing the inside wall surface 12, the unfixed outer side surface 21 being not fixed to the inside wall surface 12, a total area of the unfixed outer side surface 21 being smaller than a total area of the inside wall surface 12 to allow the buffer body 2 to be placeable in the containing space 13 of the packaging bag 1; and
a plurality of honeycomb cells 22, which are formed in the buffer body 2, each of the honeycomb cells 22 comprising a peripheral edge 221 in a polygonal form and a high edge 222 extending from the peripheral edge 221 in a vertical direction, so that the honeycomb cell 22 forms a three-dimensional (3D) configuration, the peripheral edge 221 comprising a plurality of cell edges 2211, an included angle 2212 formed between each of the cell edges 2211.

The outside wall surface 11 and the inside wall surface 12 are respectively an outer side and an inner side of the packaging bag 1.

In the instant embodiment, the prefabricated shaped form is shaped by wet drying. Specifically, the buffer body 2 is first subjected to a stretching and expanding operation, and then, a liquid is sprayed on the surface of the buffer body 2 (for example by a humidifier) to make the buffer body 2 semi-wet, and finally, the buffer body 2 is subjected to drying in a persistent stretching operation (for example by a dryer), so that the buffer body 2 becomes fixed in shape after being dried. In such a state, the plurality of honeycomb cells 22 of the buffer body 2 form an expanded 3D configuration.

The unfixed outer side surface 21 means that there is no fixing structure such as glue or binding on the surface.

In the instant embodiment, the honeycomb cell 22 is a hexagonal three-dimensional shape, namely having six cell edges 2211 and six included angles 2212, each included angle 2212 being 45 degrees to 135 degrees.

The packaging bag 1 can be one of an envelope bag, a cold-keeping bag, and a heat preservation bag, and an envelope bag is taken as an example in the instant embodiment.

The packaging bag 1 is made of a soft and flexible material, and the so-called soft and flexible material can be paper, cloth, or plastic.

The packaging bag 1 is provided with a cover member 14 for sealing the containing space 13.

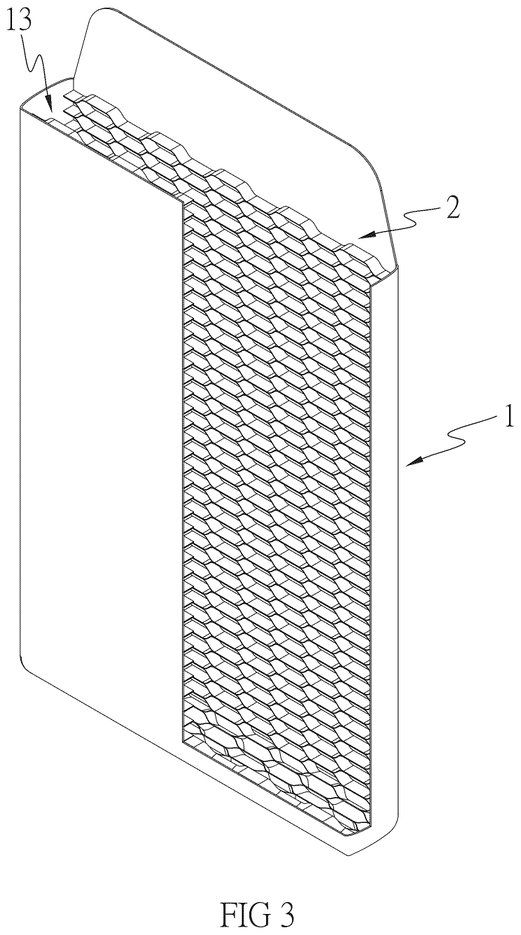

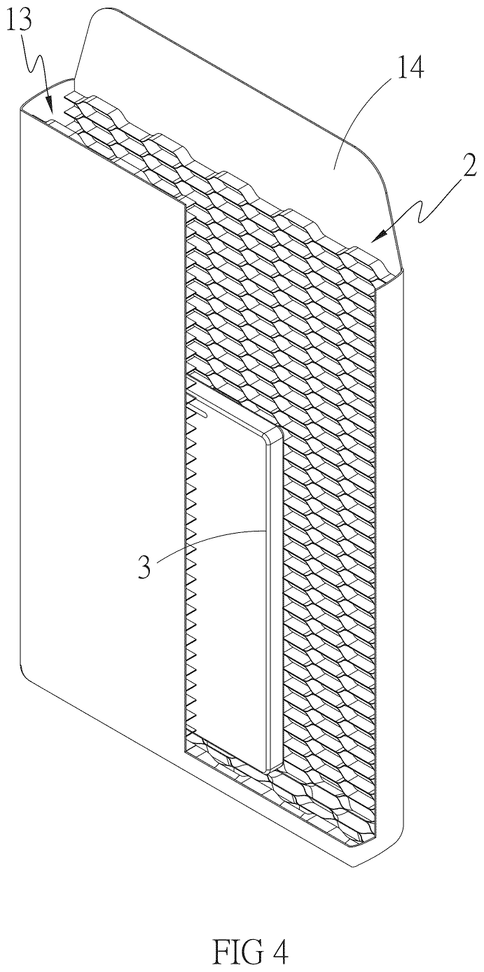

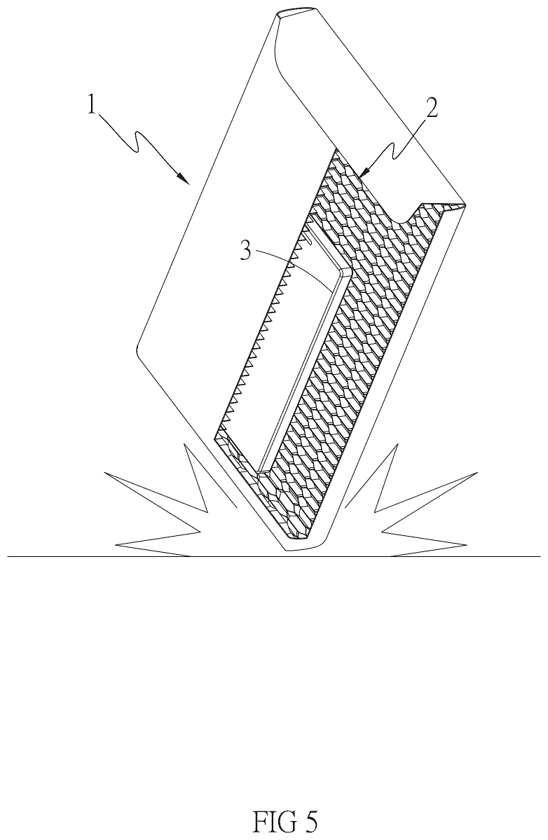

Referring to FIGS. 1-5, as can be clearly seen from FIG. 3, the buffer body 2 is already in a prefabricated shaped form before being placed into the containing space 13 of the packaging bag 1. Therefore, a user only needs to place the buffer body 2 directly into the containing space 13 from the upper opening of the packaging bag 1, without having to stretch and expand it again or conducting any operation, such as applying adhesive, to fix it with the packaging bag 1. Due to being of a three-dimensional (3D0 configuration as a whole, the buffer body 2 may fulfill an effective protection function. As shown in FIG. 4, after a merchandise object 3 is placed in the containing space 13 and the cover member 14 is closed, the shock-absorbing and buffering function fulfilled with the buffer body 2 provides a perfect protection effect for the merchandise object 3. In particular, when the merchandise object 3 is an electronic device or the merchandise object 3 is fragile and is more easily broken, more perfect protection is required, and as shown in FIG. 5, if the packaging bag laccidentally falls and hits the ground, the merchandise object 3 in the packaging bag 1 can be protected by the shock-absorption and buffering of the buffer body 2 to make the merchandise object 3 not easily damaged. In detail, referring to FIGS. 1, 2, and 5, at the moment when the packaging bag 1 hits the ground, the impact force is transmitted from the outside wall surface 11 of the packaging bag 1 to the inside wall surface 12, and then transmitted from the inside wall surface 12 to the unfixed outer side surface 21 of the buffer body 2. At this time, the impact force is dispersed, in a first stage, through the cell edges 2211 of the buffer body 2, and then, the remaining impact force is absorbed and cancelled by the high edges 222. In other words, the thickness extension direction of the high edge 222 is toward the outside of the packaging bag 1, and the impact force will be affected by a buffering distance formed by the thickness of the high edge 222 and the support of the high edge 222 by the included angle 2212, so that at the moment of receiving the impact force, the high edge 222 can be supported by the included angle 2212 and the elastic space for buffering by the buffering distance, and as such, the impact force can be effectively and completely absorbed to prevent the merchandise object 3 from being damaged.

Thus, the present invention can achieve the following advantages through the above-described technology:

Firstly, by means of the prefabricated shaped form of the buffer body 2, the user does not need to perform additional stretching on the buffer body 2, and by means of the designed arrangement of the unfixed outer side surface 21, the buffer body 2, after being placed in the containing space 13, may present a plurality of honeycomb cells 22 in an expanded three-dimensional (3D) configuration without being fixed to the inside wall surface 12 of the packaging bag 1, so that the packaging bag 1 may have the advantages of quick setup and reduced processing steps.

Secondly, the buffering space formed by the high edge 222 makes the packaging bag 1 exhibiting shock-resistant and buffering effects.

Thirdly, the buffer body 2 is made of paper and thus has the advantages of environmental protection, recyclability and decomposability.

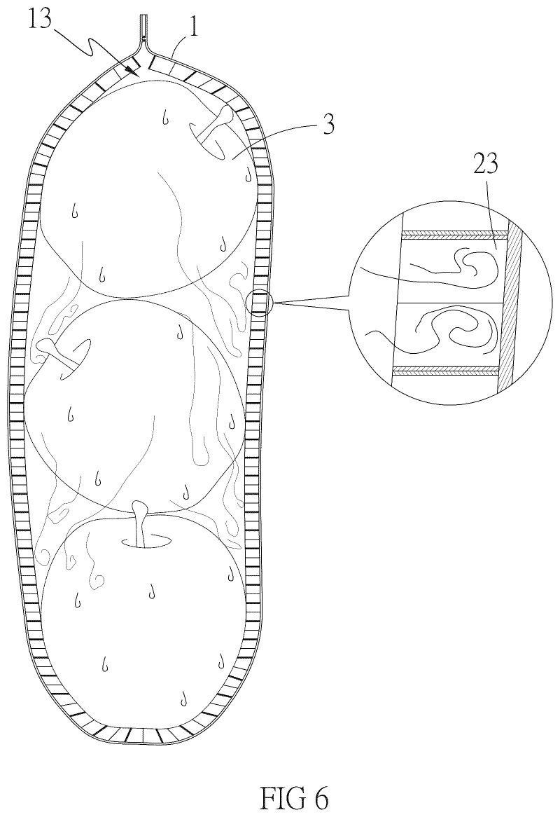

Referring to FIG. 6, in addition to electronic devices, the containing space 13 of the packaging bag 1 can also be used to store a food-grade merchandise object 3 (such as fruits). When the merchandise object 3 is taken out of a refrigerator and needs to be kept cold, the merchandise object 3 can be placed in the containing space 13, and the cold released from the merchandise object 3 can be isolated by using the air contained in the buffering space 23 as a medium, so as to achieve the advantage of keeping cold as a cold-keeping bag, this being equally applicable to heat preservation and thermal insulation.

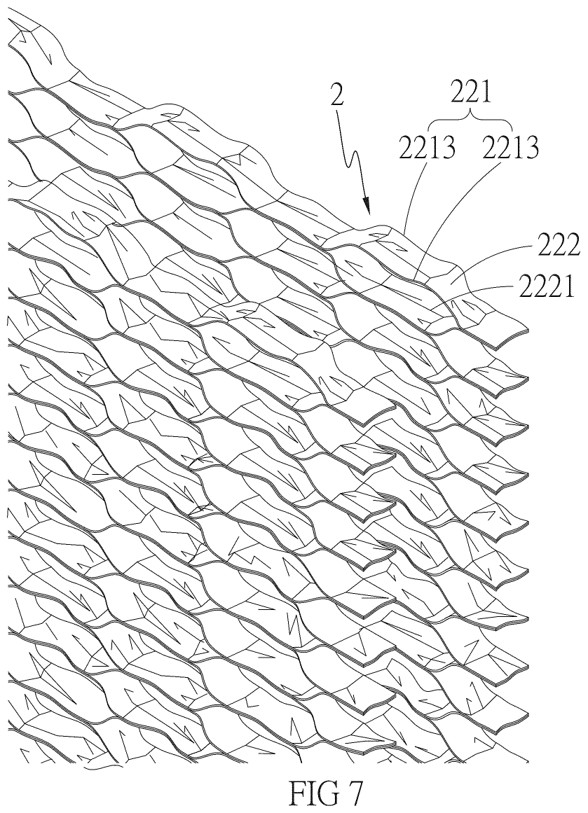

Referring to FIG. 7, the instant embodiment is different from the previous embodiment in that the prefabricated shaped form is made different. In the instant embodiment, the prefabricated shaped form is mainly to use a roller device to roll the peripheral edge 221 on the surface of the buffer body 2 so as to form at least one side fold portion 2213 on the upper and lower sides of the peripheral edge 221, and at least one middle fold portion 2221 is generated on the high edge 222. In the instant embodiment, six side fold portions 2213 on each individual side are provided as an example for illustration, and multiple middle fold portions 2221 are provided as an example for illustration. As such, the buffer body 2 does not spring back due to the fold stress of the side fold portions 2213 and the middle fold portions 2221, and thus, the buffer body 2 is set in an expanded condition through a shaped form.

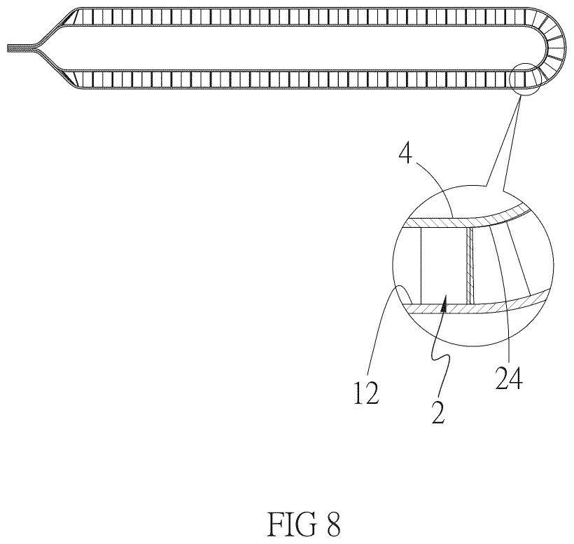

Referring to FIG. 8, the instant embodiment is mainly such that one side of the buffer body 2 facing away from the inside wall surface 12 is provided with an inner layer 4 of a soft and flexible material, and the buffer body 2 has an unfixed inner side surface 24 facing the inner layer 4, and the unfixed inner side surface 24 is not fixed on the inner layer 4, that is, there is no fixing element between the unfixed inner side surface 24 of the buffer body 2 and the inner layer 4 to connect and fix the two together, and in the manufacturing process, it is only necessary to seal the edges of the adjacent sides of the inside wall surface 12 and the inner layer 4 and, at the same time, place the buffer body 2 in the interval layer, which will be described hereinafter, before sealing the edges to complete the manufacturing process. It is obvious that it is very simple, fast and convenient as a whole, thereby increasing the competitiveness of the industry. In other words, the inside wall surface 12 and the inner layer 4 jointly define an interval layer therebetween, and the buffer body 2 is placed and set in the interval layer, so as to not only achieve the above-mentioned advantages, but also to prevent the merchandise object from hooking on and breaking the buffer body 2 and causing reduction of the buffering effect by means of the barrier achieved by the inner layer 4 between the merchandise object and the buffer body 2.

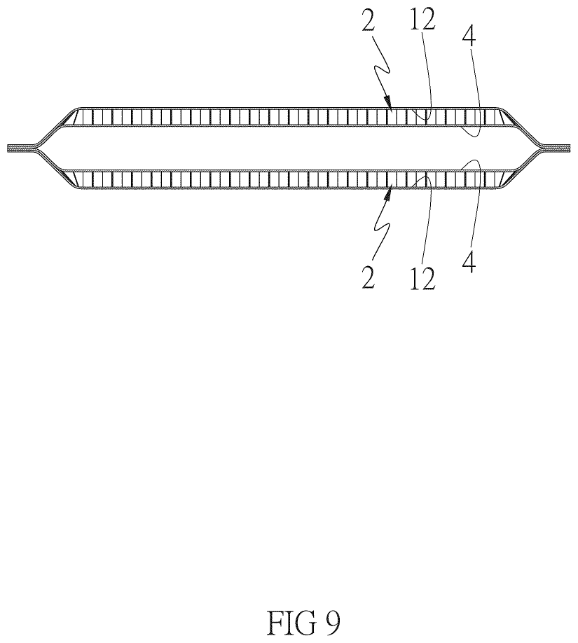

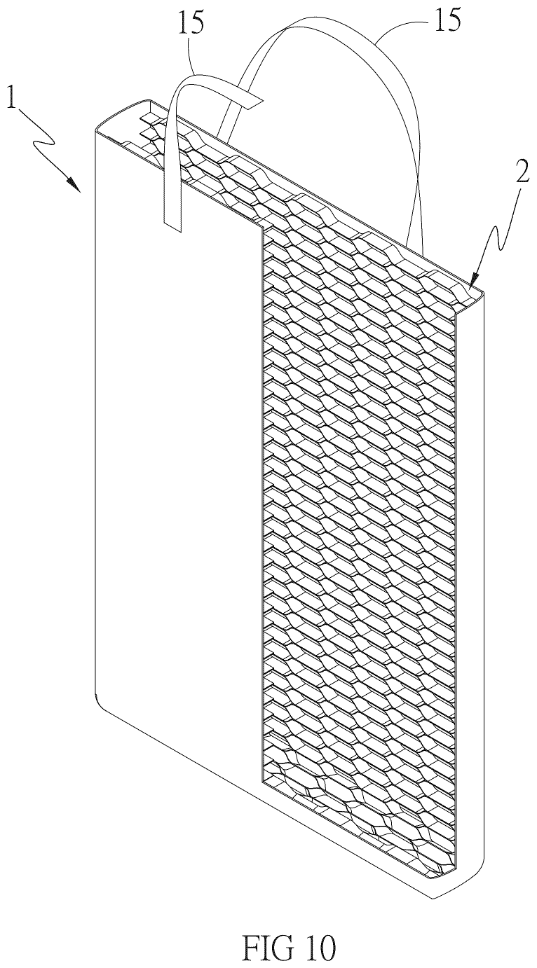

Referring to FIG. 9, the instant embodiment is different from the previous embodiment in that in the instant embodiment, as an example, the interval layer and the buffer body 2 are both taken as two, and the inside wall surface 12 and the inner layer 4 are similarly sealed at edges of adjacent sides thereof, that is, the two buffer bodies 2 are respectively placed and set in the interval layers that are not connected to and in communication with each other, and the inside wall surface 12 and the inner layer 4 are sealed at edge of four sides, so as to achieve a different configuration of arrangement. Referring to FIG. 10, the instant embodiment is mainly such that the packaging bag 1 is provided with at least one handle member 15, and the user may use the handle member 15 for easy carrying and further preventing the packaging bag 1 from failing to effectively protect the merchandise object. Even if the packaging bag 1 falls, the buffer body 2 can still protect. In the instant embodiment, the handle member 15 being arranged as two is illustrated as an example.

1. A structure of packaging bag, the packaging bag comprising:
an outside wall surface;
an inside wall surface, which is opposite to the outside wall surface, the inside wall surface surrounding and defining a containing space;
at least one buffer body, which is made in a prefabricated shaped form and disposed in the containing space, the buffer body having an unfixed outer side surface facing the inside wall surface, the unfixed outer side surface being not fixed to the inside wall surface; and
a plurality of honeycomb cells, which are formed in the buffer body, each of the honeycomb cells comprises a peripheral edge in a polygonal form and a high edge extending from the peripheral edge in a vertical direction, so as to make the honeycomb cell forming a three-dimensional configuration, the peripheral edge comprising a plurality of cell edges; wherein an included angle formed between two adjacent cell edges of the same peripheral edge is between 45 degrees and 135 degrees.

2. The structure of packaging bag according to claim 1, wherein an inner layer is provided on a side of the buffer body facing away from the inside wall surface, and the buffer body has an unfixed inner side surface facing the inner layer, the unfixed inner side surface being not fixed to the inner layer.

3. The structure of packaging bag according to claim 1, wherein the packaging bag is provided with a cover member for closing the containing space.

4. The structure of packaging bag according to claim 1, wherein the packaging bag is provided with at least one handle member.

5. (canceled)

6. The structure of packaging bag according to claim 1, wherein the packaging bag comprises one of an envelope bag, a cold-keeping bag, and a heat preservation bag.

7. The structure of packaging bag according to claim 1, wherein the buffer body is made of a biodegradable paper material.

8. The structure of packaging bag according to claim 1, wherein a total area of the unfixed outer side surface is smaller than a total area of the inside wall surface.

9. The structure of packaging bag according to claim 2, wherein the packaging bag and the inner layer comprise a material selected from paper, cloth, or plastic.
